(19) United States
(12) Patent Application Publication
(10) Pub. No.: US 2026/0086472 A1
(43) Pub. Date: Mar. 26, 2026

(54) IMAGE WRITING DEVICE AND IMAGE FORMING APPARATUS

(71) Applicant: FUJIFILM Business Innovation Corp., Tokyo (JP)

(72) Inventor: Masaki SATO, Kanagawa (JP)

(73) Assignee: FUJIFILM Business Innovation Corp., Tokyo (JP)

(21) Appl. No.: 19/063,528

(22) Filed: Feb. 26, 2025

(30) Foreign Application Priority Data
Sep. 24, 2024 (JP) 2024-164837

(51) Int. Cl. G03G 15/043

(52) U.S. Cl. CPC G03G 15/043; G03G 2215/0409

(57) ABSTRACT

An image writing device includes a writing member including an array of multiple light emitting devices that emit light for image writing; and a lighting control member that controls lighting and extinguishing of each of the light emitting devices, the lighting control member setting a light-on period for each of the light emitting devices based on an image to be written, and changing, when the light emitting devices include at least one first light emitting device for which the light-on period exceeds a predetermined range, the number of second light emitting devices to be lit, each of the second light emitting devices being disposed adjacent to the at least one first light emitting device.

### CROSS-REFERENCE TO RELATED APPLICATIONS

This application is based on and claims priority under 35 USC 119 from Japanese Patent Application No. 2024-164837 filed Sep. 24, 2024.

### BACKGROUND

### (i) Technical Field

The present disclosure relates to an image writing device and an image forming apparatus.

### (ii) Related Art

As known technologies relating to an image forming apparatuses, Japanese Unexamined Patent Application Publication Nos. 2009-119798 ([0040] to [0051]) and 2006-076121 ([0023] to [0037]) describe electrophotographic image forming apparatuses that write images on an image carrier by irradiating the image carrier with light.

Japanese Unexamined Patent Application Publication No. 2009-119798 describes a technology of correcting the amount of light emission from a light emitting element array in accordance with the density of an image in a predetermined area formed from multiple pixels. In Japanese Unexamined Patent Application Publication No. 2009-119798, in accordance with the density (gradient) formed from light emitting pixels, an area with a low lighting rate (low gradation area) has a lower output density than an intrinsic density, and thus, the current value to be applied to a light emitting device is raised for correction. Japanese Unexamined Patent Application Publication No. 2009-119798 also describes correction of an image density with correction of a pulse width, more specifically, correction of a light-on period for a light emitting device, instead of correction of the current value.

Japanese Unexamined Patent Application Publication No. 2006-076121 describes a technology of adjusting and correcting the amount of light by changing a light-amount variation correction value in accordance with the density value of an image to correct light-amount variation (in-out variation) in a scanning direction of a light emitting diode (LED) print head (LPH) (14). Japanese Unexamined Patent Application Publication No. 2006-076121 adjusts or changes the amount of light with pulse width modulation, or adjusts the amount of light by changing the ratio between a light-on period and a light-off period, more specifically, increasing or reducing the light-on period.

### SUMMARY

Aspects of non-limiting embodiments of the present disclosure relate to an expansion of an adjustable range of the amount of light compared to a case where image writing is controlled based on the light-on period for a light emitting device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image writing device including: a writing member including an array of multiple light emitting devices that emit light for image writing; and a lighting control member that controls lighting and extinguishing of each of the light emitting devices, the lighting control member setting a light-on period for each of the light emitting devices based on an image to be written, and changing, when the light emitting devices include at least one first light emitting device for which the light-on period exceeds a predetermined range, the number of second light emitting devices to be lit, each of the second light emitting devices being disposed adjacent to the at least one first light emitting device.

### BRIEF DESCRIPTION OF THE DRAWINGS

Exemplary embodiments of the present disclosure will be described in detail based on the following figures, wherein:

FIG. 1 illustrates the entirety of an image forming apparatus according to a first example;

FIG. 2 is a diagram of a related portion of an image recording portion according to the first example;

FIGS. 3A and 3B are diagrams of a light exposure device according to the first example, where FIG. 3A is the diagram of the entirety of the light exposure device, and FIG. 3B is a diagram of an array of light emitting devices;

FIG. 4 is a functional block diagram of a controller according to the first example;

FIGS. 5A, 5B, 5C, and 5D are diagrams of an example of a low-density image for which the number of light emitting devices (LEDs) to be lit according to the first example is to be changed, illustrating an input image, an exposure instruction, an image on a photoconductor, and an image printed on a paper sheet, where FIG. 5A is a diagram of an intended image, FIG. 5B is a diagram of an actually formed image, FIG. 5C is a diagram illustrating an existing technology for increasing a light-on period, and FIG. 5D is a diagram illustrating the first example;

FIGS. 6A, 6B, 6C, and 6D are diagrams illustrating an example case of changing the number of LEDs to be lit according to the first example, illustrating an input image, an exposure instruction, an image on a photoconductor, and an image printed on a paper sheet, where FIG. 6A is a diagram of an intended image, FIG. 6B is a diagram of an actually formed image, FIG. 6C is a diagram illustrating an existing technology for increasing a light-on period, and FIG. 6D is a diagram illustrating the first example; and

FIGS. 7A, 7B, 7C, and 7D are diagrams of an example of a high-density image for which the number of LEDs to be lit according to the first example is to be changed, illustrating an exposure instruction and an image printed on a paper sheet, where FIG. 7A is a diagram of an intended image, FIG. 7B is a diagram of an actually formed image, FIG. 7C is a diagram illustrating an existing technology for increasing a light-on period, and FIG. 7D is a diagram illustrating the first example.

### DETAILED DESCRIPTION

With reference now to the drawings, examples serving as specific examples of exemplary embodiments of the present disclosure are described, but the present disclosure is not limited to the examples described below.

For easy understanding of the description below, throughout the drawings, an X-axis direction denotes the front-rear direction, a Y-axis direction denotes the lateral direction, and a Z-axis direction denotes the vertical direction. The directions or sides indicated by arrows X, −X, Y, −Y, Z, and −Z are respectively referred to as forward, rearward, rightward, leftward, upward, and downward, or a front side, a rear side, a right side, a left side, an upper side, and a lower side.

Throughout the drawings, an encircled dot denotes an arrow directing from the back to the front of the sheet, and an encircled cross denotes an arrow directing from the front to the back of the sheet.

In the description with reference to the drawings, components other than those needed for the description are omitted as appropriate for ease of understanding.

### First Example

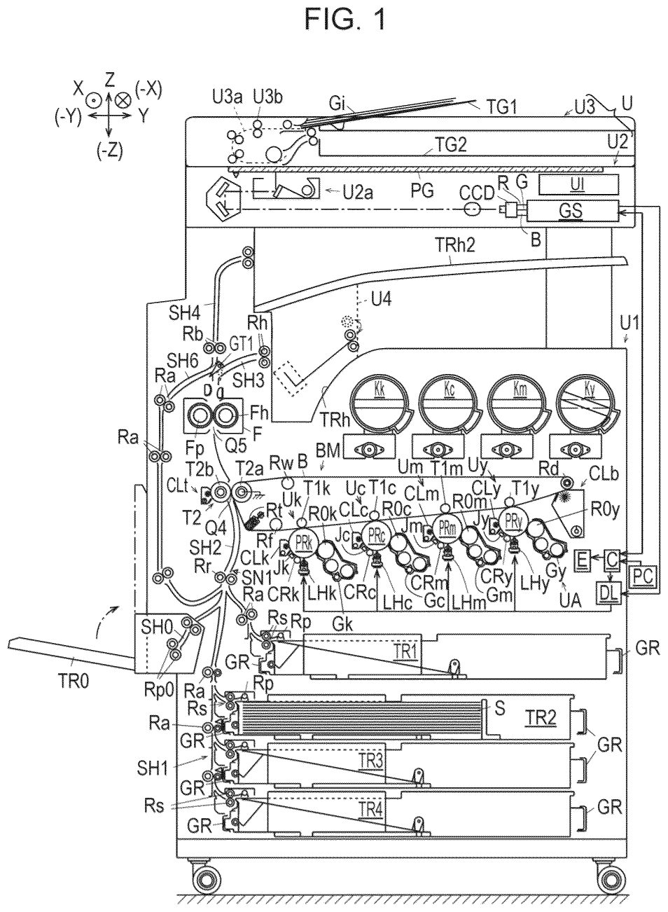

FIG. 1 illustrates the entirety of an image forming apparatus according to a first example.

In FIG. 1, a copying machine U serving as an example of the image forming apparatus according to the first example of the present disclosure includes a printer portion U1, serving as an example of an image recorder and an example of an image recording device. The printer portion U1 supports, at an upper portion, a scanner portion U2, serving as an example of a reading unit and an example of an image reading device. The scanner portion U2 supports, at an upper portion, an auto-feeder U3 serving as an example of a document transporting device.

At an upper portion of the auto-feeder U3, a document tray TG1, serving as an example of a medium container, is disposed. The document tray TG1 is capable of receiving a stack of multiple documents Gi that are to be copied. Below the document tray TG1, a document exit tray TG2 serving as an example of a document exit portion is disposed. Between the document tray TG1 and the document exit tray TG2, document transport rollers U3b are disposed along a document transport path U3a.

At the upper surface of the scanner portion U2, a platen glass PG serving as an example of a transparent document table is disposed. The scanner portion U2 according to the first example includes a reading unit U2a, which serves as an example of a reader and is disposed below the platen glass PG. The reading unit U2a according to the first example is supported to be movable in a lateral direction, serving as an example of a sub-scanning direction, along the lower surface of the platen glass PG. The reading unit U2a is electrically connected to an image processor GS.

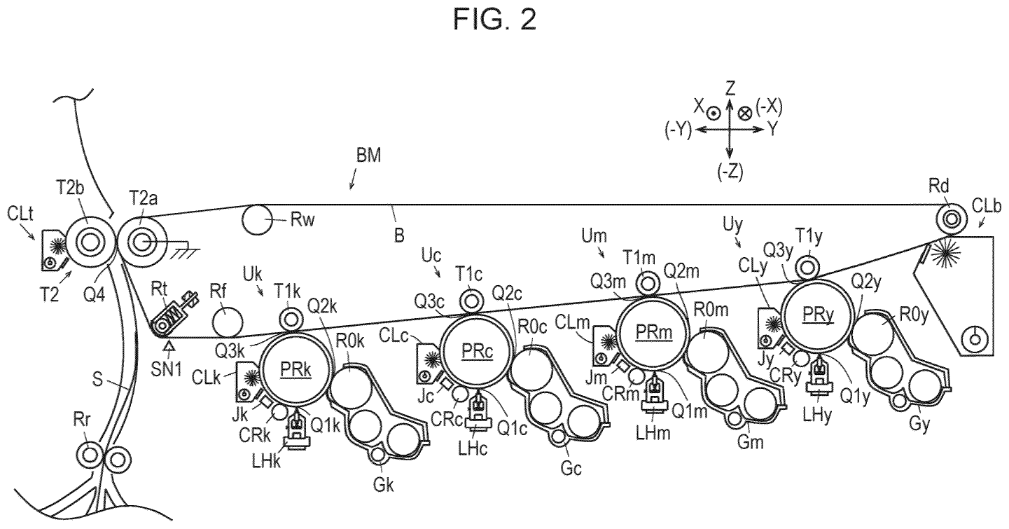

FIG. 2 is a diagram of a related portion of an image recording portion according to the first example.

The image processor GS is electrically connected to a write circuit DL in the printer portion U1. The write circuit DL is electrically connected to light exposure devices LHy, LHm, LHc, and LHk serving as examples of image writing devices.

The light exposure devices LHy to LHk according to the first example each include a light emitting diode (LED) head including multiple LEDs, serving as examples of light emitting devices, arranged on the substrate in a main scanning direction. The light exposure devices LHy to LHk are capable of outputting write light beams corresponding to colors of yellow (Y), magenta (M), cyan (C), and black (K) in accordance with signals input from the write circuit DL.

The write circuit DL or a power source circuit E are controlled in terms of write timing or power supply timing in accordance with control signals from a controller C serving as an example of a control member.

In FIG. 1, above the light exposure devices LHy to LHk, photoconductors PRy, PRm, PRc, and PRk serving as examples of image carriers are disposed. In FIG. 1 and FIG. 2, the areas of the photoconductors PRy to PRk irradiated with write light constitute write areas Q1y, Q1m, Q1c, and Q1k.

Upstream from the write areas Q1y to Q1k in rotation directions of the photoconductors PRy to PRk, charging rollers CRy, CRm, CRc, and CRk serving as examples of chargers are respectively disposed. The charging rollers CRy to CRk according to the first example are supported to be rotatably driven while being in contact with the photoconductors PRy to PRk.

Downstream from the write areas Q1y to Q1k in the rotation directions of the photoconductors PRy to PRk, developing devices Gy, Gm, Gc, and Gk serving as examples of developing members are respectively disposed. Areas where the photoconductors PRy to PRk and the developing devices Gy to Gk respectively face one another constitute development areas Q2y, Q2m, Q2c, and Q2k.

Downstream from the developing devices Gy to Gk in the rotation directions of the photoconductors PRy to PRk, first transfer rollers T1y, T1m, T1c, and T1k serving as examples of first transfer members are respectively disposed. Areas where the photoconductors PRy to PRk and the first transfer rollers T1y to T1k respectively face one another constitute first transfer areas Q3y, Q3m, Q3c, and Q3k.

Downstream from the first transfer rollers T1y to T1k in the rotation directions of the photoconductors PRy to PRk, photoconductor cleaners CLy, CLm, CLc, and CLk serving as examples of cleaners are respectively disposed.

Downstream from the photoconductor cleaners CLy to CLk in the rotation directions of the photoconductors PRy to PRk, static eliminators Jy, Jm, Jc, and Jk serving as examples of static eliminating members or examples of static eliminating devices are respectively disposed.

The photoconductor PRy, the charging roller CRy, the light exposure device LHy, the developing device Gy, the first transfer roller T1y, the photoconductor cleaner CLy, and the static eliminator Jy for the color Y constitute an image forming portion Uy for the color Y serving as an example of a visible image forming member for the color Y according to the first example that forms toner images of the color Y. Similarly, each of the photoconductors PRm, PRc, and PRk, the corresponding one of the charging rollers CRm, CRc, and CRk, the corresponding one of the light exposure devices LHm, LHc, and LHk, the corresponding one of the developing devices Gm, Gc, and Gk, the corresponding one of the first transfer rollers T1m, T1c, and T1k, the corresponding one of the photoconductor cleaners CLm, CLc, and CLk, and the corresponding one of the static eliminators Jm, Jc, and Jk constitute an image forming portion Um, Uc, or Uk for the corresponding one of the colors M, C, and K.

Above the photoconductors PRy to PRk, a belt module BM serving as an example of an intermediate transfer device is disposed. The belt module BM includes an intermediate transfer belt B serving as an example of an image carrier and an example of an intermediate transfer member. The intermediate transfer belt B is formed from an endless belt.

The intermediate transfer belt B according to the first example is rotatably supported by a tension roller Rt serving as an example of a tensioner, a walking roller Rw serving as an example of an imbalance corrector, an idler roller Rf serving as an example of a driven member, a backup roller T2a serving as an example of an opposing member opposing a second transfer area, the first transfer rollers T1y to T1k, and a driving roller Rd serving as an example of a driving member. In the first example, when a driving force is transmitted to the driving roller Rd, the intermediate transfer belt B rotates.

Downstream from the first transfer rollers T1y to T1k and between the first transfer rollers T1y to T1k and the backup roller T2a, an image detection sensor SN1 serving as an example of a detector to detect an image on the intermediate transfer belt B is disposed to face the surface of the intermediate transfer belt B.

At a position facing the backup roller T2a across the intermediate transfer belt B, a second transfer roller T2b serving as an example of a second transfer member is disposed. Components including the backup roller T2a and the second transfer roller T2b constitute a second transfer device T2 according to the first example serving as an example of a transfer device. The area where the second transfer roller T2b and the intermediate transfer belt B are in contact constitutes a second transfer area Q4.

The second transfer roller T2b according to the first example is movable between a contact position, at which the second transfer roller T2b comes into contact with the intermediate transfer belt B, and a separate position, at which the second transfer roller T2b is spaced apart from the intermediate transfer belt B.

Downstream from the second transfer area Q4 in the rotation direction of the intermediate transfer belt B, a belt cleaner CLb is disposed as an example of a cleaning device to clean the intermediate transfer body.

Components including the first transfer rollers T1y to T1k, the intermediate transfer belt B, and the second transfer device T2 constitute a transfer device T1+T2+B serving as an example of a transfer member according to the first example. The image forming portions Uy to Uk and the transfer device T1+T2+B constitute an image recording portion Uy−Uk+T1+T2+B according to the first example.

In FIG. 1, below the image forming portions Uy to Uk, four pairs of left and right guide rails GR serving as examples of guide members are disposed. On the guide rails GR, sheet feeding trays TR1, TR2, TR3, and TR4 serving as examples of medium containers are supported to be movable in and out in a front-rear direction. The sheet feeding trays TR1 to TR4 receive recording paper sheets S serving as examples of media.

At the upper left of each of the sheet feeding trays TR1 to TR4, a pickup roller Rp serving as an example of a pickup member is disposed. Downstream from the pickup roller Rp in the transport direction of the recording paper sheet S, separation rollers Rs serving as examples of separation members are disposed. Downstream from the separation rollers Rs in the transport direction of the recording paper sheet S, a sheet feeding path SH1 extending upward is disposed as an example of a medium transport path. Multiple transport rollers Ra serving as examples of transport members are disposed on the sheet feeding path SH1.

At a lower left of the copying machine U, a manual feed tray TR0 serving as an example of a medium container is disposed. At an upper right of the manual feed tray TR0, pickup rollers Rp0 are disposed, and a manual sheet feeding path SH0 extends. The manual sheet feeding path SH0 merges into the sheet feeding path SH1.

On the sheet feeding path SH1, upstream from the second transfer area Q4, registration rollers Rr serving as examples of adjusters of a transport timing are disposed. A transport path SH2 extends from the registration rollers Rr toward the second transfer area Q4.

Downstream from the second transfer area Q4 in the transport direction of the recording paper sheet S, a fixing device F serving as an example of a fixing member is disposed. The fixing device F includes a heating roller Fh serving as an example of a fixing member for heating, and a pressing roller Fp serving as an example of a fixing member for pressing. A contact area where the heating roller Fh and the pressing roller Fp are in contact constitutes a fixing area Q5.

At an upper surface of the printer portion U1, a lower paper exit tray TRh serving as an example of a medium exit portion is disposed. In the first example, at the lower paper exit tray TRh, a finisher U4 serving as an example of a postprocessing device is disposed. Above the fixing device F, a sheet exit path SH3 serving as an example of a transport path extends toward the lower paper exit tray TRh. At the downstream end of the sheet exit path SH3, discharging rollers Rh serving as examples of medium transporting members are disposed.

Above the lower paper exit tray TRh, an upper paper exit tray TRh2 serving as an example of a medium exit portion is disposed. Above the fixing device F, an upper transport path SH4 that diverges from the sheet exit path SH3 to extend toward the upper paper exit tray TRh2 is disposed.

On the upper transport path SH4, reverse rollers Rb serving as examples of medium transporting members rotatable forward and backward are disposed. Above a position where the sheet exit path SH3 and the upper transport path SH4 diverge, a reverse path SH6 serving as an example of a medium transport path diverges to the lower left from the upper transport path SH4.

A gate GT1 serving as an example of a switching member is disposed across a diverging portion at which the sheet exit path SH3 and the upper transport path SH4 diverge and a diverging portion at which the upper transport path SH4 and the reverse path SH6 diverge. The gate GT1 is supported to be switchable between a first guide position (a second position) to guide the recording paper sheet S from the fixing device F toward the lower paper exit tray TRh, and to guide the recording paper sheet S from the upper transport path SH4 to the reverse path SH6, and a second guide position (a first position) to guide the recording paper sheet S from the fixing device F toward the upper transport path SH4.

Multiple transport rollers Ra serving as examples of medium transport members are disposed on the reverse path SH6. The downstream end of the reverse path SH6 merges into the sheet feeding path SH1 upstream from the registration rollers Rr.

### Description of Image Forming Operation

When an operator manually places a document Gi on the platen glass PG to perform copying with the copying machine U according to the first example with the above structure, the reading unit U2a moves in the lateral direction from the initial position to scan the document Gi on the platen glass PG while exposing the document Gi with light. When the auto-feeder U3 is used to automatically transport documents Gi for photocopying, the multiple documents Gi received on the document tray TG1 are sequentially transported to and pass a document read position on the platen glass PG, and discharged to the document exit tray TG2. The documents Gi sequentially passing the read position on the platen glass PG are irradiated by the reading unit U2a with light to be scanned. Reflection light reflected off the documents Gi is received by the reading unit U2a. The reading unit U2a converts the received reflection light reflected off the documents Gi into electric signals. To perform both-side reading of the documents Gi, the documents Gi are also read by a reading sensor.

The image processor GS receives an input of electric signals output from the reading unit U2a. The image processor GS converts the electric signals of images of the colors R, G, and B read by the reading unit U2a into image information of yellow (Y), magenta (M), cyan (C), and black (K) for forming latent images. The image processor GS outputs the image information obtained after the conversion to the write circuit DL in the printer portion U1. To form a single-color image or a monochrome image as the image, the image processor GS outputs the image information of only black (K) to the write circuit DL.

The write circuit DL outputs control signals corresponding to the input image information to the light exposure devices LHy to LHk. The light exposure devices LHy to LHk output write light corresponding to the control signals.

Each of the photoconductors PRy to PRk is driven to rotate when the image formation is started. A charging voltage is applied to the charging rollers CRy to CRk from the power source circuit E. The surfaces of the photoconductors PRy to PRk are thus electrically charged by the charging rollers CRy to CRk. In the write areas Q1y to Q1k on the surfaces of the electrically charged photoconductors PRy to PRk, electrostatic latent images are formed by the light exposure devices LHy to LHk. The electrostatic latent images on the photoconductors PRy to PRk are developed into toner images, serving as examples of visible images, by the developing devices Gy to Gk in the development areas Q2y to Q2k.

The developed toner images are transported to the first transfer areas Q3y to Q3k at which the toner images come into contact with the intermediate transfer belt B, serving as an example of an intermediate transfer member. In the first transfer areas Q3y to Q3k, a first transfer voltage with a polarity opposite to the charging polarity of toner is applied from the power source circuit E to the first transfer rollers T1y to T1k. The toner images on the photoconductors PRy to PRk are thus transferred to the intermediate transfer belt B from the first transfer rollers T1y to T1k. To form a multi-color toner image, a toner image on the downstream side is transferred, in a superposed manner, onto a toner image that has been transferred to the intermediate transfer belt B in the upstream first transfer area.

Remnants or accretions on the photoconductors PRy to PRk that have undergone first transfer are removed by the photoconductor cleaners CLy to CLk. The surfaces of the cleaned photoconductors PRy to PRk undergo static elimination by the static eliminators Jy to Jk. The surfaces of the photoconductors PRy to PRk that have undergone static elimination are electrically charged again by the charging rollers CRy to CRk.

The single-color or multi-color toner image transferred onto the intermediate transfer belt B by the first transfer rollers T1y to T1k in the first transfer areas Q3y to Q3k is transported to the second transfer area Q4.

The recording paper sheet S on which an image is to be recorded is picked up by any of the pickup rollers Rp at the sheet feeding trays TR1 to TR4 to be used. When multiple recording paper sheets S are collectively picked up by the pickup roller Rp in a stacked manner, the multiple recording paper sheets S are separated one from another by the separation rollers Rs. The recording paper sheets S separated by the separation rollers Rs are transported by the transport rollers Ra along the sheet feeding path SH1. The recording paper sheets S transported along the sheet feeding path SH1 are transported to the registration rollers Rr. The recording paper sheets S loaded on the manual feed tray TR0 are also transported to the sheet feeding path SH1 through the manual sheet feeding path SH0 by the pickup rollers Rp0.

The registration rollers Rr transport the recording paper sheet S to the second transfer area Q4 at the timing when the toner image formed on the intermediate transfer belt B is transported to the second transfer area Q4. A second transfer voltage having a polarity opposite to the charging polarity of the toner is applied to the second transfer roller T2b by the power source circuit E. The toner image on the intermediate transfer belt B is thus transferred to the recording paper sheet S from the intermediate transfer belt B.

Accretions or other matter adhering to the surface of the intermediate transfer belt B that has undergone second transfer are removed by the belt cleaner CLb.

The recording paper sheet S to which the toner image is second transferred undergoes fixing with heat when passing the fixing area Q5.

When the recording paper sheet S to which an image is fixed is to undergo postprocessing, the recording paper sheet S is transported to the finisher U4 disposed at the lower paper exit tray TRh. When the recording paper sheet S is not to undergo postprocessing, the recording paper sheet S is transported to the upper paper exit tray TRh2. To transport the recording paper sheet S to the lower paper exit tray TRh, the gate GT1 moves to the first guide position. Thus, the recording paper sheet S fed from the fixing device F is transported along the sheet exit path SH3. The recording paper sheet S transported along the sheet exit path SH3 is transported by the discharging rollers Rh toward the finisher U4 and the lower paper exit tray TRh.

After performing a binding process, serving as an example of postprocessing, on the recording paper sheet S, the finisher U4 discharges the recording paper sheet S to the lower paper exit tray TRh.

To discharge the recording paper sheet S to the upper paper exit tray TRh2, the gate GT1 moves to the second guide position to discharge the recording paper sheet S to the upper paper exit tray TRh2.

To perform two-side printing on the recording paper sheet S, the gate GT1 moves to the second guide position. When the trailing end of the recording paper sheet S passes the gate GT1, the gate GT1 moves to the first guide position, and the reverse roller Rb rotates in the reverse direction. Thus, the recording paper sheet S is guided by the gate GT1 to be transported to the reverse path SH6. The recording paper sheet S transported along the reverse path SH6 is transported to the registration rollers Rr while being turned upside down.

### Description of Light Exposure Device

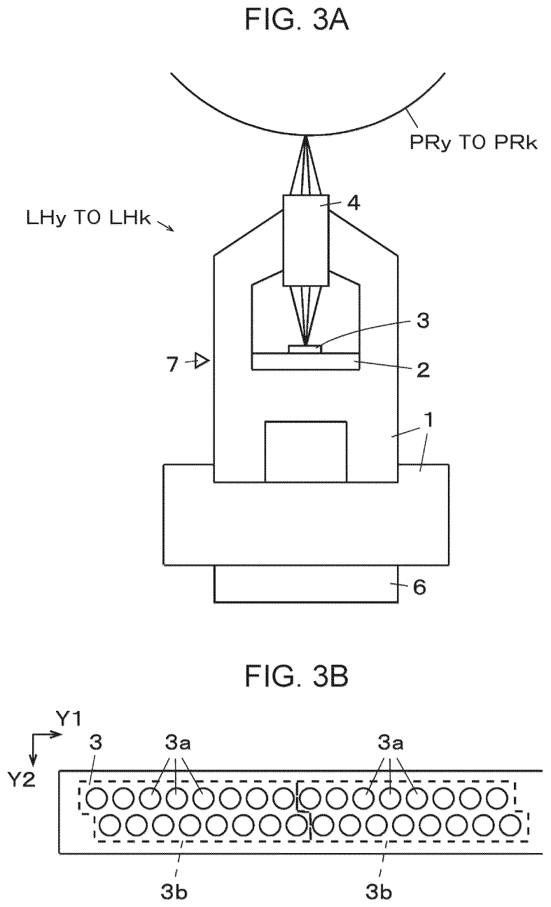

FIGS. 3A and 3B are diagrams of a light exposure device according to the first example, where FIG. 3A is the diagram of the entirety of the light exposure device, and FIG. 3B is a diagram of an array of light emitting devices.

In FIGS. 3A and 3B, the light exposure devices LHy to LHk according to the first example each include a frame 1 serving as an example of a frame body. The frame 1 extends in the main scanning direction. The frame 1 supports a substrate 2 extending in the main scanning direction. An LED array 3, serving as an example of a writing member, is disposed on the substrate 2. The LED array 3 includes multiple LEDs 3a, serving as examples of light emitting devices, arranged in the main scanning direction of the substrate 2. In FIG. 3B, the multiple LEDs 3a are arranged in rows in the main scanning direction Y1 and in columns in the sub-scanning direction Y2.

The light exposure devices LHy to LHk according to the first example each control lighting and extinguishing of the multiple LEDs 3a in units of light emitting groups 3b each including multiple LEDs. Controlling the LEDs 3a in units of light emitting groups 3b is easier than separately controlling all the LEDs 3a one by one. More specifically, controlling the lighting of the LEDs 3a in one light emitting group 3b with the same lighting pattern as another light emitting group 3b simplifies the control process. In FIG. 3A, a gradient index lens array 4 serving as an example of an optical device is supported by the frame 1 at a portion of the LED array 3 nearer a corresponding one of the photoconductors PRy to PRk.

### Description of Controller According to First Example

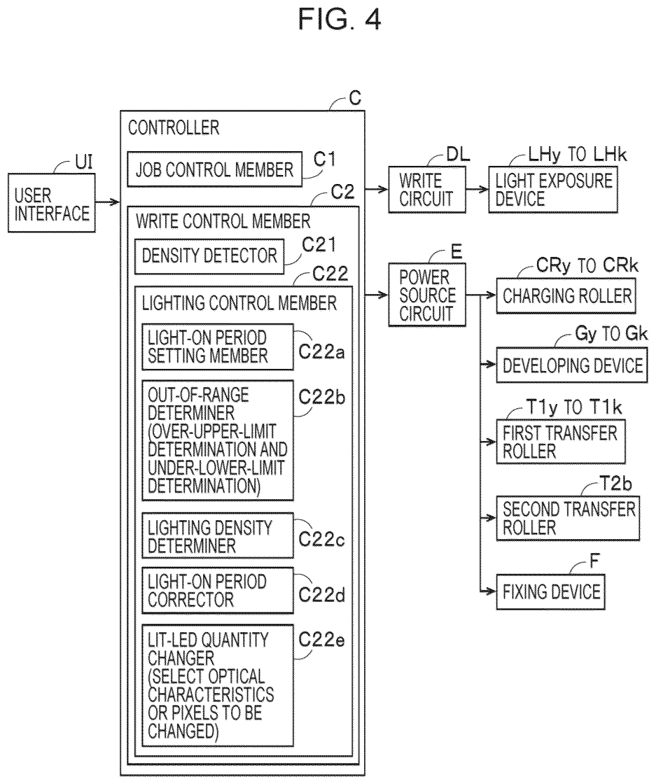

FIG. 4 is a functional block diagram of a controller according to the first example.

In FIG. 4, the controller C in the copying machine U includes an input-output interface I/O for, for example, inputs or outputs of signals from or to the external devices. The controller C includes a read only memory ROM that stores, for example, programs and information for performing intended processes. The controller C further includes a random access memory RAM that temporarily stores intended data. The controller C further includes a central processing unit CPU that performs processes in accordance with the programs stored in, for example, the ROM. The controller C according to the first example is thus formed by a small-sized information processing device, that is, a microcomputer. The controller C is thus capable of implementing various functions by executing the programs stored in, for example, the ROM.

The controller C according to the first example receives inputs of signals from a signal output element, and outputs signals to a controllable element for controlling.

### Description of Signal Output Element

The controller C receives inputs of signals from a user interface UI or other signal output elements including sensors not illustrated.

The user interface UI inputs the inputs from a user or an operator into the controller C.

### Description of Controllable Element

The controller C outputs signals to the power source circuit E, the write circuit DL, motors not illustrated, or other controllable elements not illustrated.

The power source circuit E controls, for example, charging bias to the charging rollers CRy to CRk, development bias to the developing devices Gy to Gk, first transfer bias to the first transfer rollers T1y to T1k, second transfer bias to the second transfer roller T2b, or power supply to the heater in the fixing device F.

The write circuit DL controls lighting and extinguishing of the LEDs in the LED array 3 in each of the light exposure devices LHy to LHk.

### Functions of Controller C

The controller C according to the first example has functional members (functional modules or program modules) C1 to C3 described below.

A job control member C1 controls a job serving as an image forming operation. When a job is started, the job control member C1 controls components such as the photoconductors PRy to PRk or the power source circuit E to form an image on a recording paper sheet S.

A write control member C2 includes a density detector C21 and a lighting control member C22. The write control member C2 controls the light exposure devices LHy to LHk using the write circuit DL to control writing of an image. The write control member C2 according to the first example selects LEDs to be lit based on an image read by a scanner unit U2, and controls the lighting timing or the light-on period for each LED based on the position or the density of the image.

The density detector C21 detects the density of the image read by the scanner unit U2. The density detector C21 according to the first example determines the density per pixel in the read image.

The lighting control member C22 includes a light-on period setting member C22a, an out-of-range determiner C22b, a lighting density determiner C22c, a light-on period corrector C22d, and a lit-LED quantity changer C22e. The lighting control member C22 controls the lighting and extinguishing for each light emitting device (LED).

The light-on period setting member C22a sets the light-on period for each LED in accordance with the density detected by the density detector C21. The light-on period setting member C22a according to the first example sets a longer light-on period for a higher density.

The out-of-range determiner C22b determines whether a light-on period TM1 set by the light-on period setting member C22a for any of the LEDs 3a has reached a predetermined light-on-period upper limit TMa. The out-of-range determiner C22b according to the first example also determines whether the light-on period TM1 for any of the LEDs 3a fails to reach a predetermined light-on-period lower limit TMb.

In the following description, an LED 3a that reaches the light-on-period upper limit TMa may be referred to as “an over-upper-limit LED”, and an LED 3a that fails to reach the light-on-period lower limit TMb may be referred to as “an under-lower-limit LED”. The over-upper-limit LED and the under-lower-limit LED are both light emitting devices for which the light-on period is out of a predetermined range (from the light-on-period lower limit TMb to the light-on-period upper limit TMa), and correspond to “first light emitting devices” in the scope of claims.

The LEDs 3a generally have individual differences, and the light-on period with respect to the reference amount of light (a reference light-on period TM0) is set for each of the LEDs 3a to allow the LEDs 3a to emit about the same amount of light as in a pre-shipment state. The reference light-on period TM0 thus varies among the LEDs 3a, that is, any of the LEDs 3a has a long reference light-on period TM0, and another LED 3a has a short reference light-on period TM0. Thus, when intended to emit an amount of light corresponding to an image with a high density, an LED 3a for which a long reference light-on period TM0 is originally set may fall short of the amount of light regardless of when setting the light-on period TM1 to the upper limit (the light-on-period upper limit TMa), and may form the image with an insufficient density. Similarly, when intended to form an image with a low density, an LED 3a may emit an excessive amount of light regardless of when setting the light-on period TM1 to the lower limit (the light-on-period lower limit TMb), and may form an image with an excessive density.

The lighting density determiner C22c determines lighting density, indicating the total number of light emitting devices to be lit within a predetermined frame in an image. The lighting density determiner C22c according to the first example counts the LEDs 3a to be lit within, for example, a determinable range corresponding to ten LEDs 3a (in the main scanning direction)×ten LEDs 3a (in the main sub-scanning direction) in a predetermined frame in an image to derive the lighting density M1. The lighting density determiner C22c thus determines whether the lighting density M1 is higher than a predetermined high density threshold Ma or lower than a low density threshold Mb.

The light-on period corrector C22d corrects the light-on period TM1 for each LED 3a in accordance with the lighting density M1 determined by the lighting density determiner C22c. When the lighting density M1 is higher than the high density threshold Ma, the light-on period corrector C22d according to the first example increases the light-on period for the LEDs 3a to be lit. When the lighting density M1 is lower than the low density threshold Mb, the light-on period corrector C22d according to the first example reduces the light-on period for the LEDs 3a to be lit further than when the lighting density M1 is higher than the low density threshold Mb. When the lighting density is high, a large number of LEDs 3a are lit, and the change of density is relatively greater even by performing a similar correction to the correction performed when the lighting density is intermediate or low. Thus, when the lighting density M1 is higher than the high density threshold Ma, the light-on period for the LEDs 3a is reduced further as the lighting density M1 is higher.

On the other hand, when the lighting density is low, a small number of LEDs 3a are lit, and the change of density is relatively smaller even by performing a similar correction to the correction performed when the lighting density is intermediate or high. Thus, when the lighting density M1 is lower than the low density threshold Mb, the light-on period for the LEDs 3a is increased further as the lighting density M1 is lower. The correction amount of the light-on period is found in advance through, for example, experiments to achieve image density as close as the intended image density. More specifically, individual differences among the LEDs 3a or optical characteristics are found in advance through, for example, experiments for setting the correction amount.

When the out-of-range determiner C22b determines that the light-on period TM1 for any of the LEDs 3a (an over-upper-limit LED or an under-lower-limit LED) is out of the range from the light-on-period upper limit TMa to the light-on-period lower limit TMb, the lit-LED quantity changer C22e changes the number of LEDs (examples of second light emitting devices) to be lit, disposed adjacent to the relevant LED 3a.

When the out-of-range determiner C22b determines that the LEDs 3a include the over-upper-limit LED, the lit-LED quantity changer C22e according to the first example lights at least one of the LEDs disposed adjacent to the over-upper-limit LED. More specifically, the lit-LED quantity changer C22e increases (changes) the number of LEDs 3a to be lit.

When the out-of-range determiner C22b determines that that the LEDs 3a include the under-lower-limit LED, the lit-LED quantity changer C22e according to the first example extinguishes at least one of the LEDs 3a to be lit in the LEDs 3a disposed adjacent to the under-lower-limit LED. More specifically, the lit-LED quantity changer C22e reduces (changes) the number of LEDs 3a to be lit.

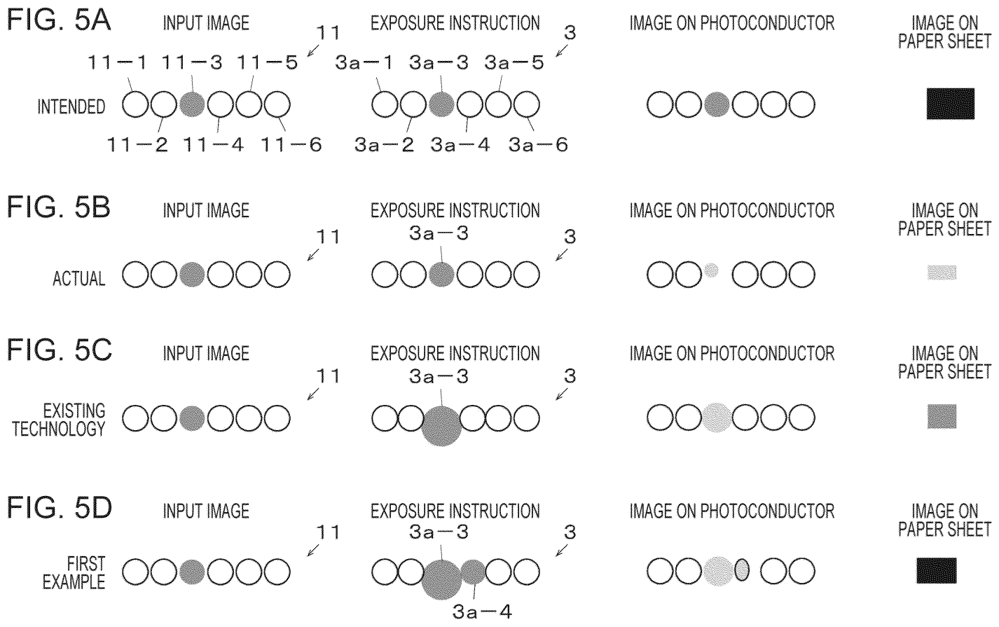

FIGS. 5A, 5B, 5C, and 5D are diagrams of an example of a low-density image for which the number of light emitting devices (LEDs) to be lit according to the first example is to be changed, illustrating an input image, an exposure instruction, an image on a photoconductor, and an image printed on a paper sheet, where FIG. 5A is a diagram of an intended image, FIG. 5B is a diagram of an image actually formed, FIG. 5C is a diagram illustrating an existing technology for increasing a light-on period, and FIG. 5D is a diagram illustrating the first example.

In FIGS. 5A, 5B, 5C, and 5D, as illustrated in FIG. 5A, when a third pixel 11-3 in six pixels 11 in an input image is to undergo writing, a corresponding third LED 3a-3 is controlled to be lit. When the LED 3a-3 is lit, an image (a dot) is formed at a corresponding position on each of the photoconductors PRy to PRk. The image (dot) on each of the photoconductors PRy to PRk is transferred to and fixed on a paper sheet. However, due to the individual differences of the LED 3a-3 or the optical characteristics of the lens array 4, the amount of light may run short regardless of when the LED 3a-3 is lit for the same light-on period as a standard LED 3a. In this case, as illustrated in FIG. 5B, the density or the size of the image on each of the photoconductors PRy to PRk fails to be reproduced in the same manner as the input image. Thus, the image transferred to the paper sheet has low reproducibility with respect to the input image.

In contrast, in the existing technologies described in Japanese Unexamined Patent Application Publication Nos. 2009-119798 and 2006-076121, the light-on period for the LED 3a-3 with low reproducibility is increased to improve the reproducibility of the image density. However, in a high-speed machine that prints a large number of sheets per unit time, the photoconductors PRy to PRk rotate at a high speed and the light exposure devices LHy to LHk emit light for a limited period. An increase of the light-on period is thus limited. Regardless of when the light-on period is increased up to the limit, as illustrated in FIG. 5C, the reproducibility of the density or the position of the image may be insufficient.

In the first example, when the LEDs include the over-upper-limit LED 3a-3, an LED 3a-4 disposed adjacent to the over-upper-limit LED 3a-3 is lit. Thus, as illustrated in FIG. 5D, the amount of light that has been insufficient regardless of when the LED 3a-3 is lit to the maximum is securable using these two LEDs 3a-3 and 3a-4. The first example thus improves reproducibility of the density or the position of an image on a paper sheet with respect to the input image further than the existing technologies illustrated in FIG. 5C.

In the example illustrated in FIG. 5D, the LED 3a-4 on the right of the over-upper-limit LED 3a-3 is lit. This is because the over-upper-limit LED 3a-3 exceeds the upper limit, and the shortage of the amount of light in the over-upper-limit LED 3a-3 is more easily addressed by using the adjacent LED 3a-4. However, the LED to be lit is not limited to the right LED 3a-4. For example, an LED 3a-2 on the left in the main scanning direction may be lit. Instead, an LED adjacent in the sub-scanning direction may be lit. Instead of lighting a single LED, two or more LEDs may be lit when appropriate in accordance with, for example, an experiment to secure the reproducibility. Thus, in the first example, the number of LEDs 3a to be lit when the LEDs 3a include the over-upper-limit LED 3a-3 is changed based not only on the individual differences between the LEDs 3a or the density or the position of the image, but also on the optical characteristics of the lens array 4.

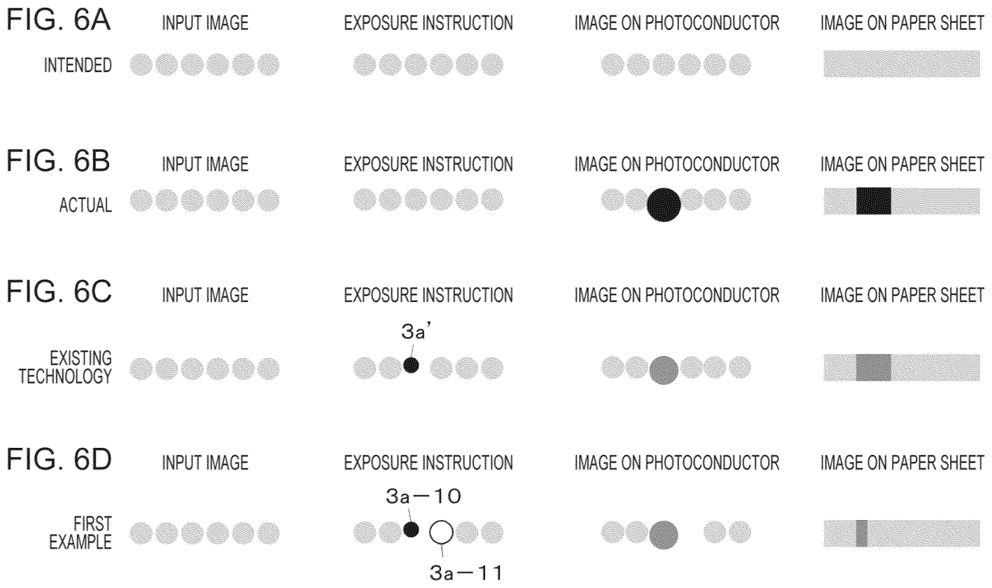

FIGS. 6A, 6B, 6C, and 6D are diagrams illustrating an example case of changing the number of LEDs to be lit according to the first example, illustrating an input image, an exposure instruction, an image on a photoconductor, and an image printed on a paper sheet, where FIG. 6A is a diagram of an intended image, FIG. 6B is a diagram of an image actually formed, FIG. 6C is a diagram illustrating an existing technology for increasing a light-on period, and FIG. 6D is a diagram illustrating the first example.

In FIGS. 6A, 6B, 6C, and 6D, when the light-on period is excessively short, the light-on period ends before the current or the voltage is stabilized on the circuit, and the amount of light emission of the LEDs 3a fails to be stabilized. Thus, the light-on period longer than the light-on-period lower limit TMb taken to stabilize the amount of light emission is secured. However, regardless of when the LEDs 3a are lit for a period longer than the light-on-period lower limit TMb, dots with excessively high image density may occur due to the individual differences among the LEDs 3a or the optical characteristics of the lens array 4. Thus, as illustrated in FIG. 6B, the reproducibility may be actually lowered with respect to an intended state illustrated in FIG. 6A due to, for example, the individual differences or the optical characteristics. As in the existing technologies of simply reducing the light-on period for an LED 3a′ described in Japanese Unexamined Patent Application Publication Nos. 2009-119798 and 2006-076121, as illustrated in FIG. 6C, the reproducibility is insufficient for an intended image illustrated in FIG. 6A. In contrast, in the first example, an LED 3a-11 that is disposed adjacent to an under-lower-limit LED 3a-10 and that is to be lit is extinguished. Thus, as illustrated in FIG. 6D, the first example forms an image more closely analogous to an intended image in FIG. 6A than an image in FIG. 6C formed by an existing technology, and thus has improved reproducibility.

In the example illustrated in FIG. 6D, the LED 3a-11 on the right of the under-lower-limit LED 3a-10 is extinguished, but the LED to be extinguished is not limited to this. As in the case described with reference to FIG. 5D, an LED on the left or an LED adjacent in the sub-scanning direction may be extinguished, or two or more LEDs may be extinguished. Thus, in the first example, the number of LEDs 3a to be lit when the LEDs 3a include the under-lower-limit LED 3a-10 is changed based not only on the individual differences between the LEDs 3a or the density or the position of the image, but also on the optical characteristics of the lens array 4.

The lit-LED quantity changer C22e according to the first example corrects the number of LEDs 3a to be lit in accordance with the lighting density determined by the lighting density determiner C22c. When the lighting density M1 is higher than the high density threshold Ma, the lit-LED quantity changer C22e according to the first example further reduces the number of LEDs 3a to be lit within the determinable range than when the lighting density M1 is lower than the high density threshold Ma. When the lighting density is high, a large number of LEDs 3a are lit, and the change of density is relatively greater even by performing a similar correction to the correction performed when the lighting density is intermediate or low. Thus, when the lighting density M1 is higher than the high density threshold Ma, the number of LEDs 3a to be lit is reduced further as the lighting density M1 is higher, and the light-on period for the LEDs 3a to be lit is increased to achieve an amount of light and density as close as the intended amount of light and the intended density. The number of reduction of LEDs to be lit and the light-on period are found in advance through, for example, experiments, and set to achieve image density as close as the intended image density. Depending on, for example, the individual differences among the LEDs 3a or the optical characteristics of the lens array 4, the number of LEDs to be lit may be simply reduced without correcting the light-on period.

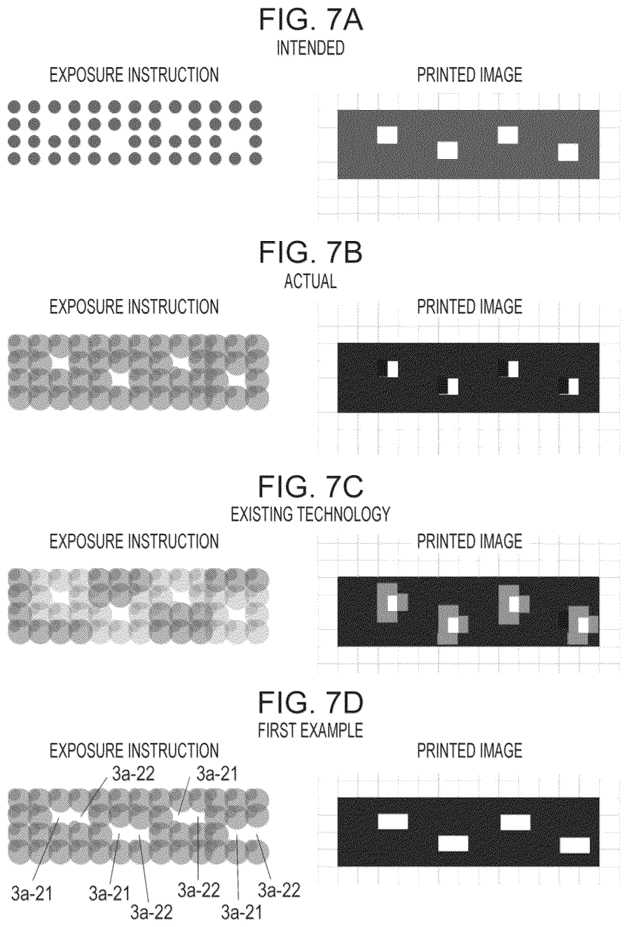

FIGS. 7A, 7B, 7C, and 7D are diagrams of an example of a high-density image for which the number of LEDs to be lit according to the first example is to be changed, illustrating an exposure instruction and an image printed on a paper sheet, where FIG. 7A is a diagram of an intended image, FIG. 7B is a diagram of an image actually formed, FIG. 7C is a diagram illustrating an existing technology for increasing a light-on period, and FIG. 7D is a diagram illustrating the first example.

In FIGS. 7A, 7B, 7C, and 7D, to form an image with high lighting density, an image illustrated in FIG. 7B may be formed with respect to an intended image illustrated FIG. 7A due to, for example, the individual differences among the LEDs 3a or the optical characteristics of the lens array 4. As illustrated in FIG. 7C, the technologies described in Japanese Unexamined Patent Application Publication Nos. 2009-119798 and 2006-076121 reduce the light-on period for some of the LEDs to form an image as closely analogous to the intended image (FIG. 7A). In contrast, in the first example, LEDs 3a-22 that are to be lit and that are disposed adjacent to unlit LEDs 3a-21 are extinguished, or more specifically, the number of LEDs that are to be lit is reduced. Thus, as illustrated in FIG. 7D, the first example forms an image more closely analogous to an intended image in FIG. 7A than the image in FIG. 7C. Thus, the first example has reproducibility improved further than the existing technology.

When the lighting density M1 is lower than the low density threshold Mb, the lit-LED quantity changer C22e according to the first example increases the number of LEDs 3a to be lit within a determinable range further than when the lighting density M1 is higher than the low density threshold Mb. When the lighting density is low, a small number of LEDs 3a are lit, and the change of density is relatively smaller even by performing a similar correction to the correction performed when the lighting density is intermediate or low. Thus, when the lighting density M1 is lower than the low density threshold Mb, the number of LEDs 3a to be lit is increased further as the lighting density M1 is lower, and the light-on period for the LEDs 3a to be lit is reduced to achieve an amount of light and density as close as the intended amount of light and the intended density. The number of an increase of LEDs to be lit and the light-on period are found in advance through, for example, experiments, and set to achieve image density as close as the intended image density. Depending on, for example, the individual differences among the LEDs 3a or the optical characteristics of the lens array 4, the number of LEDs to be lit may be simply increased without correcting the light-on period.

The first example performs determination based on the lighting density M1, but this example is not limitative. For example, the lighting density M1 also relates to the image density (area coverage), and thus the number of LEDs to be lit may be increased or reduced based on the image density.

### Operations of First Example

The copying machine U according to the first example with the above structure changes the number of LEDs to be lit when the LEDs include an over-upper-limit LED or an under-lower-limit LED. Thus, regardless of when incapable of fully adjusting or correcting the amount of light with an adjustment of the light-on period, the copying machine U is capable of adjusting the amount of light to be an intended amount of light by increasing or reducing the number of LEDs to be lit. Thus, the copying machine U is capable of further expanding the adjustable range of the amount of light than the technologies described in Japanese Unexamined Patent Application Publication Nos. 2009-119798 and 2006-076121 for controlling the writing of an image simply with the light-on period for each LED.

In addition, the copying machine U according to the first example corrects the number of LEDs 3a to be lit and the light-on period in accordance with the lighting density, and thus has improved reproducibility regardless of when the lighting density is high or low. The copying machine U according to the first example also corrects the number of LEDs to be lit and the light-on period in consideration of the optical characteristics of the lens array 4. Thus, the copying machine U according to the first example has reproducibility further improved than when the optical characteristics are not taken into consideration.

### Modification Examples

Although an exemplary embodiment of the present disclosure has been described in detail above, the present disclosure is not limited to the above example, and may be modified in various manners within the scope of the gist of the present disclosure described in the scope of claims. Modification examples (H01) to (H04) of the present disclosure are described below.
(H01) As the image forming apparatus according to the above example, a copying machine U has been described, but the present disclosure is not limited to this. For example, the image forming apparatus may be formed from a printer, a fax machine, or a multifunction machine having multiple or all the functions of these.
   (H02) The apparatus according to the above example employing four-color developers is described as an example of the copying machine U, but the present disclosure is not limited to this. For example, the copying machine U is also applicable to a single-color image forming apparatus or a multi-color image forming apparatus using three or less colors or five or more colors.
(H03) In the above example, the endless intermediate transfer belt B is described as an example of an image carrier, but the present disclosure is not limited to this. For example, the image carrier may be a cylindrical intermediate transfer drum, a photoconductor drum, or a photoconductor belt. Instead, the present disclosure is also applicable to a structure that includes no intermediate transfer body and that directly records an image from a photoconductor to a recording paper sheet S.
   (H04) In the above example, the array of the LEDs 3a is not limited to the array described above, and may have any form. For example, the LEDs 3a may be arranged simply in one row in the main scanning direction, or may be arranged in a large number of columns in the sub-scanning direction. In addition, for example, a copying machine U capable of receiving the A3 size may include two or more LED arrays 3 having a length in the main scanning direction corresponding to a A4 size, arranged side by side in the main scanning direction.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) An image writing device, comprising:
   a writing member including an array of a plurality of light emitting devices that emit light for image writing; and
   a lighting control member that controls lighting and extinguishing of each of the plurality of light emitting devices, the lighting control member setting a light-on period for each of the plurality of light emitting devices based on an image to be written, and changing, when the plurality of light emitting devices include at least one first light emitting device for which the light-on period exceeds a predetermined range, the number of second light emitting devices to be lit, each of the second light emitting devices being disposed adjacent to the at least one first light emitting device.
(((2))) The image writing device according to (((1))),
   wherein the lighting control member lights the second light emitting device when the light-on period for the first light emitting device reaches a predetermined upper limit of the period.
(((3))) The image writing device according to (((1))) or (((2))),
   wherein the lighting control member extinguishes the second light emitting device when the light-on period for the first light emitting device fails to reach a predetermined lower limit of the period.
(((4))) The image writing device according to any one of (((1))) to (((3))),
   wherein the lighting control member corrects the light-on period for each of the plurality of light emitting devices in accordance with lighting density indicating a total number of light emitting devices to be lit within a predetermined frame in an image.
(((5))) The image writing device according to (((4))),
   wherein when the lighting density is higher than a predetermined value, the number of light emitting devices to be lit is reduced and the light-on period for the light emitting devices to be lit is increased further than when the lighting density is lower than the predetermined value.
(((6))) The image writing device according to (((4))) or (((5))),
   wherein when the lighting density is lower than a predetermined value, the number of light emitting devices to be lit is increased and the light-on period for the light emitting devices to be lit is reduced further than when the lighting density is higher than the predetermined value.
(((7))) The image writing device according to any one of (((1))) to (((6))),
   wherein the lighting control member controls lighting and extinguishing of the plurality of light emitting devices in a unit of a group including the plurality of light emitting devices.
(((8))) The image writing device according to any one of (((1))) to (((7))), further comprising:
   an optical member that irradiates an image carrier with light output from each of the plurality of light emitting devices,
   wherein the lighting control member changes the number of light emitting devices to be lit based on characteristics of the optical member in each of the plurality of light emitting devices.
(((9))) The image writing device according to (((8))),
   wherein when the lighting density is higher than a predetermined value, the number of light emitting devices to be lit is reduced further than when the lighting density is lower than the predetermined value.
(((10))) The image writing device according to (((8))) or (((9))),
   wherein when the lighting density is lower than a predetermined value, the number of the light emitting devices to be lit is increased further than when the lighting density is higher than the predetermined value.
(((11))) The image writing device according to any one of (((1))) to (((10))),
   wherein the number of the second light emitting devices adjacent to the first light emitting device in a main scanning direction of the written image is changed.
(((12))) An image forming apparatus, comprising:
   an image carrier;
   the image writing device according to any one of (((1))) to (((11))) that forms a latent image on the image carrier;
   a developing member that develops the latent image written by the image writing device;
   a transfer member that transfers an image obtained with development performed by the developing member to a medium; and
   a fixing member that fixes the image transferred to the medium.

What is claimed is:

1. An image writing device, comprising:
a writing member including an array of a plurality of light emitting devices that emit light for image writing; and
a lighting control member that controls lighting and extinguishing of each of the plurality of light emitting devices, the lighting control member setting a light-on period for each of the plurality of light emitting devices based on an image to be written, and changing, when the plurality of light emitting devices include at least one first light emitting device for which the light-on period exceeds a predetermined range, the number of second light emitting devices to be lit, each of the second light emitting devices being disposed adjacent to the at least one first light emitting device.

2. The image writing device according to claim 1,
wherein the lighting control member lights the second light emitting device when the light-on period for the first light emitting device reaches a predetermined upper limit of the period.

3. The image writing device according to claim 1,
wherein the lighting control member extinguishes the second light emitting device when the light-on period for the first light emitting device fails to reach a predetermined lower limit of the period.

4. The image writing device according to claim 1,
wherein the lighting control member corrects the light-on period for each of the plurality of light emitting devices in accordance with lighting density indicating a total number of light emitting devices to be lit within a predetermined frame in an image.

5. The image writing device according to claim 4,
wherein when the lighting density is higher than a predetermined value, the number of light emitting devices to be lit is reduced and the light-on period for the light emitting devices to be lit is increased further than when the lighting density is lower than the predetermined value.

6. The image writing device according to claim 4,
wherein when the lighting density is lower than a predetermined value, the number of light emitting devices to be lit is increased and the light-on period for the light emitting devices to be lit is reduced further than when the lighting density is higher than the predetermined value.

7. The image writing device according to claim 1,
wherein the lighting control member controls lighting and extinguishing of the plurality of light emitting devices in a unit of a group including the plurality of light emitting devices.

8. The image writing device according to claim 1, further comprising:
an optical member that irradiates an image carrier with light output from each of the plurality of light emitting devices,
wherein the lighting control member changes the number of light emitting devices to be lit based on characteristics of the optical member in each of the plurality of light emitting devices.

9. The image writing device according to claim 8,
wherein when the lighting density is higher than a predetermined value, the number of light emitting devices to be lit is reduced further than when the lighting density is lower than the predetermined value.

10. The image writing device according to claim 8,
wherein when the lighting density is lower than a predetermined value, the number of the light emitting devices to be lit is increased further than when the lighting density is higher than the predetermined value.

11. The image writing device according to claim 1,
wherein the number of the second light emitting devices adjacent to the first light emitting device in a main scanning direction of the written image is changed.

12. An image forming apparatus, comprising:
an image carrier;
the image writing device according to claim 1 that forms a latent image on the image carrier;
a developing member that develops the latent image written by the image writing device;
a transfer member that transfers an image obtained with development performed by the developing member to a medium; and
a fixing member that fixes the image transferred to the medium.

13. An image forming apparatus, comprising:
an image carrier;
the image writing device according to claim 2 that forms a latent image on the image carrier;
a developing member that develops the latent image written by the image writing device;
a transfer member that transfers an image obtained with development performed by the developing member to a medium; and
a fixing member that fixes the image transferred to the medium.

14. An image forming apparatus, comprising:
an image carrier;
the image writing device according to claim 3 that forms a latent image on the image carrier;
a developing member that develops the latent image written by the image writing device;
a transfer member that transfers an image obtained with development performed by the developing member to a medium; and
a fixing member that fixes the image transferred to the medium.

15. An image forming apparatus, comprising:
an image carrier;
the image writing device according to claim 4 that forms a latent image on the image carrier;
a developing member that develops the latent image written by the image writing device;
a transfer member that transfers an image obtained with development performed by the developing member to a medium; and
a fixing member that fixes the image transferred to the medium.

16. An image forming apparatus, comprising:
an image carrier;
the image writing device according to claim 5 that forms a latent image on the image carrier;
a developing member that develops the latent image written by the image writing device;
a transfer member that transfers an image obtained with development performed by the developing member to a medium; and
a fixing member that fixes the image transferred to the medium.

17. An image forming apparatus, comprising:
an image carrier;
the image writing device according to claim 6 that forms a latent image on the image carrier;
a developing member that develops the latent image written by the image writing device;
a transfer member that transfers an image obtained with development performed by the developing member to a medium; and
a fixing member that fixes the image transferred to the medium.

18. An image forming apparatus, comprising:
an image carrier;
the image writing device according to claim 7 that forms a latent image on the image carrier;
a developing member that develops the latent image written by the image writing device;
a transfer member that transfers an image obtained with development performed by the developing member to a medium; and
a fixing member that fixes the image transferred to the medium.

19. An image forming apparatus, comprising:
an image carrier;
the image writing device according to claim 8 that forms a latent image on the image carrier;
a developing member that develops the latent image written by the image writing device;
a transfer member that transfers an image obtained with development performed by the developing member to a medium; and
a fixing member that fixes the image transferred to the medium.

20. An image forming apparatus, comprising:
an image carrier;
the image writing device according to claim 9 that forms a latent image on the image carrier;
a developing member that develops the latent image written by the image writing device;
a transfer member that transfers an image obtained with development performed by the developing member to a medium; and
a fixing member that fixes the image transferred to the medium.
